(19) United States
(12) Patent Application Publication
(10) Pub. No.: US 2009/0152825 A1
(43) Pub. Date: Jun. 18, 2009

(54) BAG RETAINER/TRANSPORTER AND METHOD OF USE THEREOF

(76) Inventor: Adrine Sue Adams, Fayetteville, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 11/955,623

(22) Filed: Dec. 13, 2007

(51) Int. Cl. B62B 1/06; B65D 33/00

(52) U.S. Cl. 280/47.31; 383/33

(57) ABSTRACT

A bag retainer/transporter comprising a floor, a bag mount, a frame and at least one wheel, wherein the bag mount is either generally rectangular or circular in shape. The bag retainer/transporter has a bag mount that may be selectively pivoted parallel to the frame, wherein the bag retainer/transporter is utilized as a cart. To use, a bag is placed into the bag mount and stretched around the perimeter of the bag mount. The user then places waste or material into the bag and transports the waste to another location. To store, the bag mount is pivoted to the frame, the floor is pivoted to the frame, and the floor is secured to the frame via at least one fastener. The bag retainer/transporter can subsequently be moved to a storing location.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to a bag retainer/Transporter, and more specifically to a bag retainer/transporter comprising a frame, a pivoting mount for securing a bag in an open position, and a pivoting base to supper the bag when full.

2. Description of Related Art

Typically, waste is placed into a bag and transported to another location for disposal. However, full waste bags are heavy and difficult to transport. Further, waste transportation units are difficult to store when not in use.

Unfortunately, because waste transportation units are cumbersome and awkward to operate, a user will often carry waste without a transportation unit and risk the possibility of tearing or ripping the bag, thereby disgorging the contents of the bag. Such a possibility is not only hazardous to the environment, but also can cause injury or serious health problems if the user is exposed to toxic or harmful waste.

One method of relieving the difficulty of transporting waste has been the use of a dolly or similar device. While utilizing such devices can transport waste materials, such devices often do not have a means to support a bag in an open position. Thus, the user has the cumbersome task of simultaneously placing waste into the bag while holding the bag open, which is both inefficient and tiresome.

Another device capable of transporting waste is a cart with a means for supporting the open end of a trash bag. However, while such a device is capable of supporting and moving a bag filled with waste, due to its bulk, such device may not be suitable for efficient storage when the cart is not in use.

Therefore, it is readily apparent that there is a need for a bag retainer and transporter that can transport waste and can easily be folded and stored when not in use.

### BRIEF SUMMARY OF THE INVENTION

Briefly described, in a preferred embodiment, the present invention overcomes the above-mentioned disadvantages and meets the recognized need for such an apparatus by providing a bag retainer/transporter and method of use thereof, wherein the bag retainer/transporter comprises a floor, a bag mount, a frame and at least one wheel, and wherein the bag mount is either generally rectangular or circular in shape. Additionally, the floor and the bag mount are selectively pivoted parallel to the frame, and the floor is secured to the frame via at least one fastener.

The bag retainer/transporter is efficient to both utilize and store. The bag retainer/transporter is efficient to utilize because it secures a bag in an open position around the bag mount and easily transports the bag on a frame to a desired location. Additionally, the bag retainer/transporter is efficient to store because the bag mount and the floor can selectively be folded parallel to the frame, forming a generally flat structure efficient for storage when not in use.

According to its major aspects and broadly stated, the present invention in its preferred form is a bag retainer/transporter and method of use thereof, wherein the bag retainer/transporter comprises a floor, a bag mount, a frame, and at least one wheel that is disposed proximate the rear of the floor and the bottom of the frame.

The floor has one or more feet for support on the ground when holding a bag or other object. The floor is pivotable to a position parallel against the frame and secured via at least one fastener when not in use. An axle is located between the floor and the frame to pivotally secure the floor to the frame.

Additionally, the bag mount has a front support, a rear support, a right side support and a left side support. The bag mount is either generally rectangular or circular in shape and selectively pivots parallel the frame.

The bag retainer/transporter provides a method of removing waste. The user places a bag having an open end into the bag mount. The user then stretches the perimeter of the bag around the support structure of the bag mount, secures the perimeter of the bag to the support structure, and subsequently places waste into the bag and transports the waste.

Further, when the bag retainer/transporter is not in use, the user has the option to pivot the bag mount against the frame, pivot the floor against the frame, and secure the floor to the frame via at least one fastener, thereby also securing the bag mount. The resulting form is a generally flat structure.

Thus, the bag retainer/transporter provides an apparatus capable of transporting waste in a cart while supporting the open end of the trash bag. Additionally, the bag retainer/transporter can be folded into a flat structure capable of being easily and efficiently stored when not in use.

More specifically, the present invention is a bag retainer/transporter having a floor, a bag mount, a frame and at least one wheel. The bag mount has a front support, a rear support, a right side support and a left side support.

The frame has a bottom, a top, a left side member, a right side member, a center member, a upper bar, a lower bar and a middle bar. The frame also has a handle disposed at the top thereof.

Additionally, the floor has a front, a rear, at least one foot at the front of the floor and at least one aperture at the front of the floor. The floor pivots toward the frame around an axle, wherein the axle has at least one wheel rotationally secured thereto. The axle and the floor comprise cooperative portions of a hinge that permits pivots of the floor against the frame.

In use, the floor is pivoted downward about the axle and feet provides support between the floor and the ground. The bag mount is subsequently pivoted upward on a locking hinge until it is parallel to the floor, wherein the bag mount latches in place when it is fully raised. A user then places a bag into the bag mount and secures the periphery of the bag around the bag mount, which comprises a front support, a rear support, a right side support and a left side support. The user subsequently places waste into the bag and transports the bag retainer/transporter by pushing and/or pulling the handle, wherein the bag retainer/transporter is rolled to a selected location.

When the bag retainer/transporter is not in use, the bag mount is unlatched and rotated downward via the hinge until it is parallel to the frame. The user can then utilize the bag retainer/transporter as a cart to transport any material, such as boxes or heavy objects, to a selected location.

Alternatively, if the bag mount is already folded parallel to the frame and the user is storing the bag retainer/transporter, the user selectively rotates the floor upward around the axle toward the frame, until the floor is parallel to the frame and over the bag mount. The floor is thereby secured to the frame via at least one side fastener. It will be recognized by those skilled in the art that any fastener could be utilized, such as, for exemplary purposes only, a strap and buckle, an interference fit pin and aperture, or the like. Once the bag retainer/transporter is folded, the user selectively pushes and/or pulls the bag retainer/transporter via the handle to a selected storage location.

In an alternate embodiment the bag retainer/transporter has a bag mount that is generally circular.

Thus, the bag retainer/transporter provides a safe and effective way for a user to collect and transport waste. The bag retainer/transporter can also be utilized as a cart when the bag mount is parallel to the frame. Further, the bag mount and the floor can be folded toward the frame, thereby creating a generally flat structure that is easy to store when not in use.

Accordingly, a feature and advantage of the present invention is its ability to easily support the open end of a bag for insertion of waste or other material thereinto.

Another feature and advantage of the present invention is its ability to easily transport a full bag to another location.

Still another feature and advantage of the present invention is its ability to also operate as a cart to transport objects when the bag mount is not in use.

Yet another feature and advantage of the present invention is its ability to form a generally flat apparatus for efficient storage when not in use.

Yet still another feature and advantage of the present invention is avoiding hazards to the environment and to the user by safely transporting waste.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a perspective view of a bag retainer/transporter according to a preferred embodiment of the present invention;

FIG. 2 is a perspective view of a bag retainer/transporter according to a preferred embodiment of the present invention, shown with bag installed;

FIG. 3 is a perspective view of a bag retainer/transporter according to a preferred embodiment of the present invention, shown folded for storage; and

FIG. 4 is a perspective view of a bag retainer/transporter according to an alternate embodiment of the present invention.

### DETAILED DESCRIPTION OF THE PREFERRED AND SELECTED ALTERNATE EMBODIMENTS OF THE INVENTION

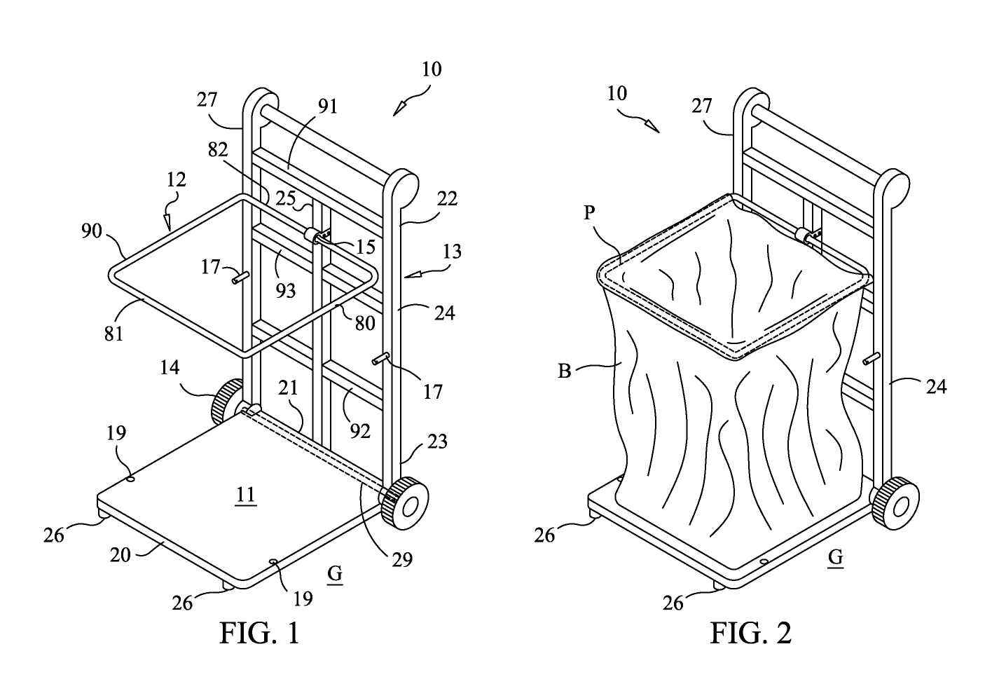

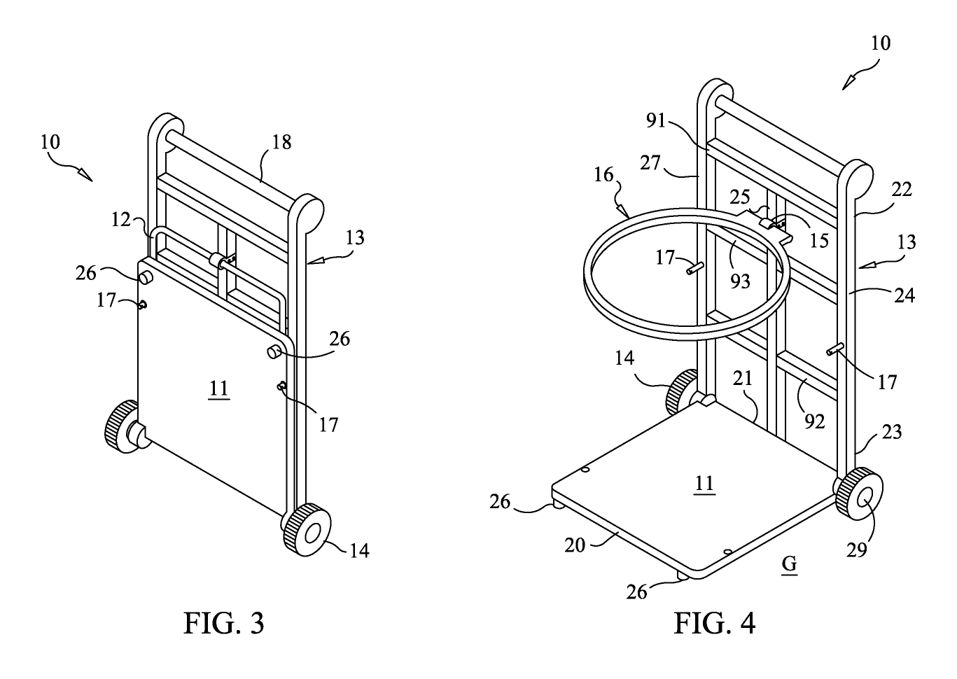

In describing the preferred and selected alternate embodiments of the present invention, as illustrated in FIGS. 1-4, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention in a preferred embodiment comprises bag retainer/transporter 10, wherein bag retainer/transporter 10 preferably comprises floor 11, bag mount 12, frame 13 and at least one wheel 14, wherein bag mount 12 preferably comprises front support 81, rear support 82, right side support 90 and left side support 80. Front support 81, rear support 82, right side support 90 and left side support 80 preferably form a quadrilateral polygon. It will be recognized by those skilled in the art that other polygons could be formed by three of front support 81, rear support 82, right side support 90 and left side support 80, such as, for exemplary purposes only, a triangle.

Frame 13 preferably comprises bottom 23, top 22, left side member 24, right side member 27, center member 25, upper bar 91, lower bar 92 and middle bar 93. Frame 13 further preferably comprises handle 18 disposed at top 22 of frame 13.

Floor 11 preferably comprises front 20, rear 21 and at least one foot 26 preferably disposed at front 20 of floor 11. Floor 11 preferably pivots toward frame 13 around axle 29, wherein axle 29 is preferably retained by frame 13 and preferably comprises at least one wheel 14, and wherein axle 29 and floor 11 preferably cooperate to permit folding of floor 11.

In use, floor 11 is preferably pivoted downward about axle 29, wherein at least one foot 26 preferably provides support between floor 11 and ground G. Bag mount 12 is preferably subsequently pivoted upward via hinge 15 until it is parallel to floor 11. Hinge 15 preferably latches to support bag mount 12 in a horizontal disposition. A user then preferably places bag B into bag mount 12 and preferably secures the periphery P of bag B around front support 81, rear support 82, right side support 90 and left side support 80, utilizing any means known in the art for securing an open bag to a rail. The user preferably subsequently places waste into bag B and transports bag retainer/transporter 10 by pushing and/or pulling handle 18, wherein bag retainer/transporter 10 is preferably rolled on at least one wheel 14 to a selected location.

When bag retainer/transporter 10 is not in use, bag mount 12 is preferably unlatched and rotated downward via hinge 15 until it is parallel to frame 13. The user can then utilize bag retainer/transporter 10 as a cart to transport any material, such as boxes or heavy objects, to a selected location.

Alternatively, if bag mount 12 is already parallel to the frame 13 and the user is storing bag retainer/transporter 10, the user selectively rotates upward floor 11 around axle 29 toward frame 13, until floor 11 is parallel to frame 13. Floor 11 is then secured to frame 13 via pin 17, wherein pin 17 engages with aperture 19 of floor 11 to retain floor 11 proximate frame 13. Pin 17 could be tapered, or alternately, could comprise a resiliently deformable oversized head, wherein once pin 17 is pushed through aperture 19, it the head prevents the pin from being withdrawn until a selected amount of force is applied. It will be recognized by those skilled in the art that any means of fastening could be utilized to secure floor 11 to frame 13, such as, for exemplary purposes only, a strap and buckle. Once bag retainer/transporter 10 is folded, the user selectively pushes and/or pulls bag retainer/transporter 10 via handle 18, wherein bag retainer/transporter 10 rolls on at least one wheel 14 to selected location.

Referring now more specifically to FIG. 4, illustrated therein is an alternate embodiment of bag retainer/transporter 10, wherein the alternate embodiment of FIG. 4 is substantially equivalent in form and function to that of the preferred embodiment detailed and illustrated in FIGS. 1-3, except as hereinafter specifically referenced. Specifically, the embodiment of bag retainer/transporter 10 comprises bag mount 16, wherein bag mount 16 is generally circular.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A bag retainer/transporter comprising:
a floor;
a bag mount;
a frame; and
at least one wheel.

2. The bag retainer/transporter of claim 1, wherein said at least one wheel is disposed proximate a first end of said floor and a bottom end of said frame.

3. The bag retainer/transporter of claim 1, wherein said floor is pivotable onto a disposition proximate and parallel to said frame.

4. The bag retainer/transporter of claim 3, wherein said floor is secured to said frame via at least one fastener when not in use.

5. The bag retainer/transporter claim 1, wherein said floor comprises at least one foot.

6. The bag retainer/transporter of claim 1, wherein said bag mount comprises a front support, a rear support, a left side support and a right side support.

7. The bag retainer/transporter of claim 6, wherein said bag mount is pivotable to a disposition proximate and parallel to said frame.

8. The bag retainer/transporter of claim 1, wherein said frame comprises a handle disposed proximate a top portion of said frame.

9. The bag retainer/transporter of claim 1, wherein said bag mount comprises a generally circular bag support structure.

10. The bag retainer/transporter of claim 1, further comprising an axle.

11. The bag retainer/transporter of claim 1, wherein said floor and said bag mount are parallel said frame when folded, and wherein said bag retainer/transporter is generally flat.

12. The bag retainer/transporter of claim 4, wherein said bag mount is pivoted into a disposition proximate and parallel to said frame, and wherein said bag mount is disposed between said floor and said frame when said bag mount and said floor are pivoted into said disposition proximate and parallel to said frame.

13. A method of removing waste, said method comprising the steps of:
placing a bag having a perimeter into a carrier comprising a bag mount having a support structure;
stretching the bag around said support structure of said bag mount;
securing the perimeter of the bag to said support structure;
placing waste into the bag; and
transporting the waste.

14. The method of claim 13, wherein said carrier comprises a floor and a frame, said method further comprising of the step of:
pivoting said bag mount proximate to said frame.

15. The method of claim 14, said method further comprising the step of:
pivoting said floor proximate to said frame.

16. The method of claim 15, said method further comprising the step of:
securing said floor to said frame via at least one fastener.

17. The method of claim 16, said method further comprising the step of:
rolling said carrier to a storing location.

18. A bag transport comprising:
a floor;
a bag mount;
and a frame, wherein said floor and said bag mount are parallel to said frame when folded, and wherein said bag transport is generally flat when folded for storage.

19. The bag transport of claim 18, wherein said bag mount is disposed between said floor and said frame when said bag transport is folded for storage.

20. The bag transport of claim 19, wherein said bag mount is selected from the group consisting of circular bag mounts and quadrilateral bag mounts.
